(19) United States
(12) Patent Application Publication
(10) Pub. No.: US 2011/0002681 A1
(43) Pub. Date: Jan. 6, 2011

(54) IMAGING APPARATUS

(75) Inventor: Hiroshi Yamashita, Ichinomiya-City (JP)

Correspondence Address: DITTHAVONG MORI & STEINER, P.C., 918 Prince Street, Alexandria, VA, 22314, US

(73) Assignee: SANYO Electric Co., Ltd., Moriguchi-shi (JP)

(21) Appl. No.: 12/868,084

(22) Filed: Aug. 25, 2010

Related U.S. Application Data
(63) Continuation of application No. PCT/JP2009/050639, filed on Jan. 19, 2009.

(30) Foreign Application Priority Data
Feb. 26, 2008 (JP) 2008-044675

(51) Int. Cl. G03B 13/34

(52) U.S. Cl. 396/133

(57) ABSTRACT

An imaging apparatus includes a holder which holds a lens, a supporting unit which supports the holder so as to be displaced, a magnet which is arranged on any one of the holder and the supporting member, a coil which generates an electromagnetic driving force on the holder, a magnetic member which holds the holder at a position after the current supply is stopped with a magnetic force generated between the magnet and the magnetic member, when the current supply to the coil is stopped, and a control unit which driving-controls the holder by applying a current signal to the coil. When the holder is displaced to the reference position, the control unit applies a first pulse current signal to the coil, then applies a second pulse current signal of which application time is shorter than that of the first pulse current signal to the coil a plurality of times.

This application claims priority under 35 U.S.C. Section 119 of Japanese Patent Application No. 2008-044675 filed Feb. 26, 2008, entitled “IMAGING APPARATUS”. The disclosure of the above applications is incorporated herein by reference.

### BACKGROUND OF THE INVENTION

1. Field of the Invention

The present invention relates to an imaging apparatus, in particular, relates to an imaging apparatus which is suitably applied to a camera, a mobile phone equipped with a camera, or the like.

2. Disclosure of Related Art

There is a mobile phone equipped with a camera, which includes a so-called macro photographing function in addition to a photographing function for photographing a subject from a position at a distance to some extent. The macro photographing function is a function for photographing a subject from a close position. In this case, an imaging apparatus including a configuration for switching lens positions between a normal photographing time and a macro photographing time is mounted on the mobile phone. That is to say, in the configuration, a lens is fixed at a first position at the time of the normal photographing and fixed at a second position which is closer to a subject in comparison with the first position at the time of the macro photographing.

The imaging apparatus having such functions is configured as follows, for example. A lens is supported in an outer frame member so as to be displaced in the optical axis direction thereof. The lens is biased to a position at the time of the normal photographing by a spring. Further, a ring-form rotational member which is rotatable in a surface perpendicular to the optical axis of the lens is attached to the outer frame member. A magnet is arranged on the rotational member and a magnet is also arranged on the lens. If a user rotates the rotational member, the magnet at the side of the rotational member approaches to the magnet at the side of the lens. Further, if the rotational member is rotationally moved to a position where both of the magnets are opposed to each other, the lens is displaced to a position at the time of the macro photographing with an attractive force generated between these magnets against a biasing force by the spring.

However, in the above imaging apparatus, a user rotationally moves the rotational member manually so as to switch the position of the lens to the position at the time of macro photographing. Therefore, at the time of switching to the macro photographing, a troublesome operation is required for a user. In order to solve the problem, if the switching to the macro photographing can be electrically performed, the lens can be displaced to the position at the time of the macro photographing with a simple operation such as an operation with a button, for example. Further, the lens position can be automatically switched in accordance with a distance between the subject and the imaging apparatus, thereby enhancing a user's convenience.

In the imaging apparatus having the macro photographing function, a lens has to be positioned at a position at the time of the macro photographing (hereinafter, referred to as “macro position”) and at a position at the time of the normal photographing (hereinafter, referred to as “normal position”) appropriately in order to smoothly perform the macro photographing and the normal photographing. That is to say, if the lens is deviated from the normal position or the macro position, a focus error is caused with respect to an image sensor (for example, CCD: Charge Coupled Device), resulting in blurring in a photographed image. Accordingly, a configuration for appropriately positioning the lens to the macro position and the normal position is also required in a case where the lens is electrically driven as described above.

On the other hand, there is an imaging apparatus having a so-called auto-focus function. With the auto-focus function, the lens is not fixed to the normal position or the macro position not likely in the above configuration and the lens is focused to an appropriate focus position (on-focus position). In this case, a configuration in which the lens is driven with a magnetic force generated between a magnet and a coil can be considered as one of mechanisms for automatically focusing.

With the configuration, the lens is positioned at the on-focus position in the following manner, for example. That is to say, when the auto-focus operation is started, a pulse current signal is applied to the coil a predetermined number of times so that the lens is gradually displaced from a home position in the optical axis direction of the lens. Every time the lens is displaced with one application of the pulse current signal, a contrast value of an image captured by the lens is detected based on a signal from the image sensor. The detection of the contrast value is repeated until the lens reaches from the home position to a terminal position of a focus adjustment region by applying the pulse current signal a required number of times. At this time, the contrast value becomes maximum when the lens is positioned at the on-focus position. Thereafter, what number of application of the pulse current signal makes the contrast value maximum is extracted. Then, after the lens is returned to the home position once, the lens is displaced again by applying the pulse current signals by the extracted number of times. Therefore, the lens is positioned at a position where the contrast value becomes maximum, that is, at an on-focus position.

With such configuration, the home position corresponds to a reference position when the lens is focused. Therefore, if the lens is not appropriately positioned at the home position, a risk that the on-focus position is deviated is caused. Accordingly, a configuration for appropriately positioning the lens at the home position is required in the imaging apparatus including such auto-focus mechanism.

### SUMMARY OF THE INVENTION

An imaging apparatus according to main aspect of the invention includes a holder which holds a lens, a supporting unit which supports the holder so as to be displaced in the optical axis direction of the lens, an abutment unit which is provided on the supporting unit and abuts against the holder when the holder is positioned at a predetermined reference position, a magnet which is arranged on any one of the holder and the supporting member, a coil which is arranged so as to be opposed to the magnet and generates an electromagnetic driving force on the holder with the magnet when an electric current is applied, a magnetic member which holds the holder at a position after the current supply is stopped with a magnetic force generated between the magnet and the magnetic member, when the current supply to the coil is stopped, and a control unit which driving-controls the holder by applying a current signal to the coil. In the imaging apparatus, when the holder is displaced to the reference position, the control unit applies a first pulse current signal to the coil, then applies a second pulse current signal of which application time is shorter than that of the first pulse current signal to the coil a plurality of times.

In the imaging apparatus according to the main aspect of the invention, when the holder is displaced to the reference position, the first pulse current signal is applied to the coil, at first. Therefore, the holder is displaced to the vicinity of the reference position. Subsequently, the second pulse current signal is applied to the coil a plurality of times. Therefore, the holder gradually approaches to the reference position, and eventually abuts against the abutment unit so as to reach to the reference position. Thereafter, the holder positioned at the reference position is held at the position with a magnetic force generated between the magnet and the magnetic member.

### BRIEF DESCRIPTION OF THE DRAWINGS

The above and other objects and novel characteristics of the invention are made obvious more perfectly by reading the following description of embodiments and the following accompanying drawings.

FIG. 1 is an exploded perspective view illustrating a configuration of a lens driving apparatus according to the embodiment.

FIGS. 2A and 2B are assembly perspective views illustrating a configuration of the lens driving apparatus according to the embodiment.

FIGS. 3A and 3B are views for explaining a driving operation of the lens driving apparatus according to the embodiment.

FIGS. 4A, 4B and 4C are views illustrating a configuration for holding a lens holder according to the embodiment.

FIGS. 5A and 5B are views illustrating a modification of a magnetic plate according to the embodiment.

FIG. 6 is a view illustrating a configuration of an imaging apparatus according to the embodiment.

FIGS. 7A, 7B, 7C and 7D are views for explaining a drive control of the lens driving apparatus according to the embodiment.

FIGS. 8A and 8B are views illustrating a motion of the lens holder when the lens holder is driven by a short pulse signal according to the embodiment.

FIG. 9 is a view illustrating a modification of a pulse current signal for driving the lens holder according to the embodiment.

FIG. 10 is an exploded perspective view illustrating a configuration of a lens driving apparatus according to another embodiment.

FIGS. 11A and 11B are assembly perspective views illustrating a configuration of the lens driving apparatus according to another embodiment.

FIG. 12 is a view illustrating a configuration of an imaging apparatus according to another embodiment.

FIG. 13 is a view illustrating a pulse current signal for driving a lens holder according to another embodiment.

It is to be noted that the drawings are intended to explain the invention only and are not intended to limit a range of the invention.

### DESCRIPTION OF PREFERRED EMBODIMENTS

Hereinafter, an embodiment of the invention will be described with reference to drawings. An imaging apparatus according to the embodiment is obtained by applying the invention to an imaging apparatus without an auto-focus function. That is to say, in the embodiment, a position of a lens is fixed so as to be switchable between two positions of a position when a normal photographing is performed (normal position) and a position when a macro photographing is performed (macro position). Here, the imaging apparatus includes a so-called macro switching lens driving device which can switch the lens position between the normal position and the macro position.

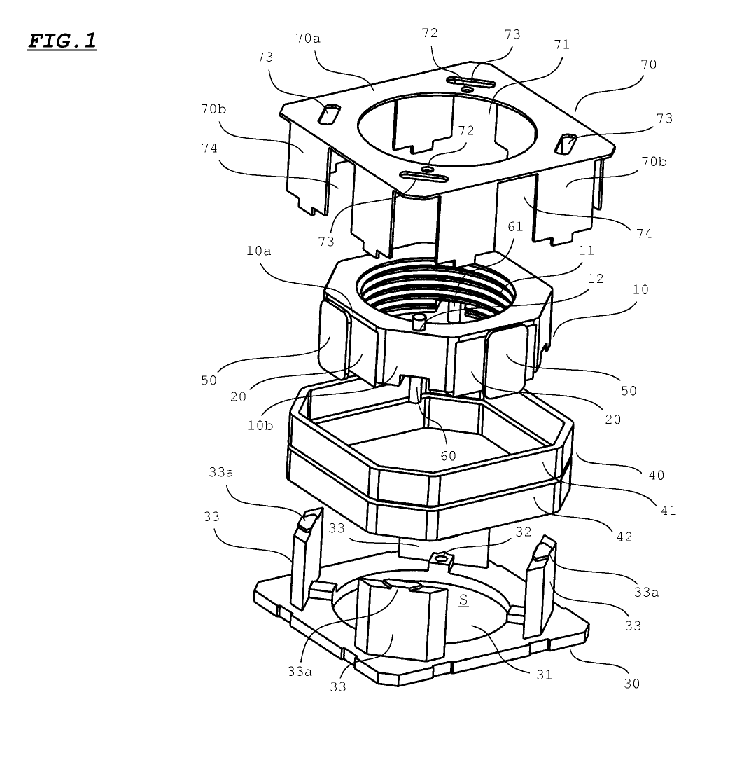

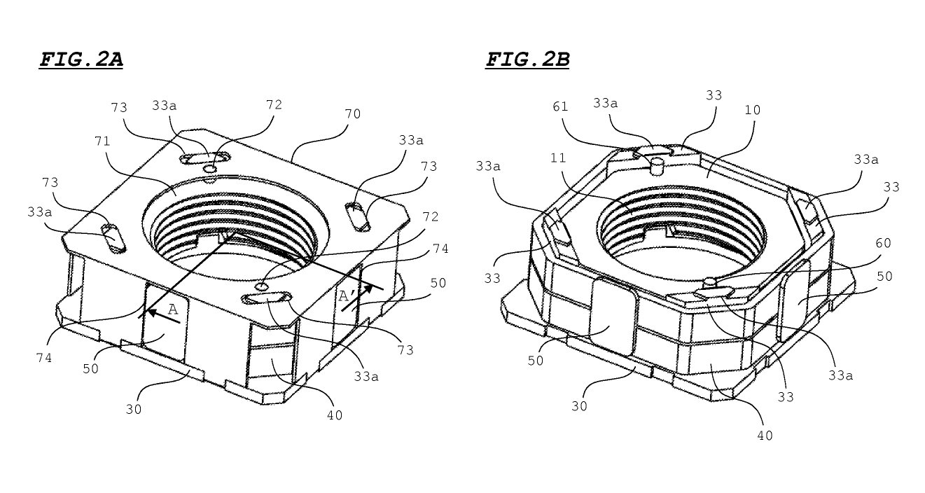

FIG. 1 is an exploded perspective view illustrating the lens driving apparatus according to the embodiment. FIGS. 2A and 2B are views illustrating a configuration of the lens driving apparatus after assembled. FIG. 2A is a view illustrating the lens driving apparatus after completely assembled. FIG. 2B is a view illustrating a state where a cover 70 is removed from the lens driving apparatus so as to see an internal state of the lens driving apparatus as shown in FIG. 2A.

A reference numeral 10 indicates a lens holder. The lens holder 10 has an octagon shape in a plan view. A circular opening 11 for accommodating a lens is formed at the center of the lens holder 10. Eight side faces of the lens holder 10 are arranged so as to be symmetric with respect to an optical axis of the lens attached to the opening 11. These eight side faces are composed of four side faces 10a having a large width and four side faces 10b having a small width. The side faces 10a and the side faces 10b are alternately arranged in the lens holder 10.

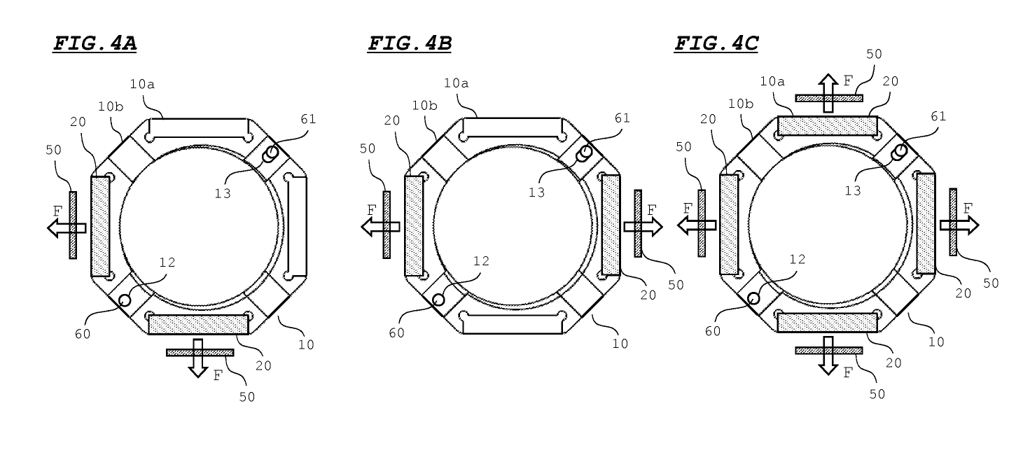

Further, a circular hole 12 and a long hole 13 which engage with two shafts 60, 61 respectively, are formed on the lens holder 10 (see, FIGS. 4A to 4C). A magnet 20 is attached to each of one side face 10a and one side face 10a perpendicular to the above side face 10a among four side faces 10a having a large widths in the lens holder 10. These two magnets 20 have a two-poles arrangement configuration in which an N pole and an S pole are magnetized on side faces. Further, the sizes and the magnetic intensities of the magnets 20 are the same.

A reference numeral 30 indicates a base. The base 30 is formed into a substantially square plate form. An opening 31 for introducing light transmitted through the lens to an image sensor is formed on the base 30. Further, two holes 32 to which the shafts 60, 61 are inserted are formed on the base 30. Note that only one hole 32 is illustrated in FIG. 1.

In addition, four guiding members 33 are provided so as to protrude on the periphery of the opening 31. A convex 33a is formed on each of distal ends of these guiding members 33. Note that a space surrounded by these four guiding members 33 corresponds to an accommodating space S of the lens holder 10.

A reference numeral 40 indicates a coil. The coil 40 is winded around an outer circumference of the four guiding members 33. The coil 40 is composed of a first coil 41 and a second coil 42. The first coil 41 and the second coil 42 are connected to each other in series. Winding directions of the first coil 41 and the second coil 42 are opposite to each other. Therefore, current flowing directions in the first coil 41 and the second coil 42 are opposite to each other.

A reference numeral 50 indicates two magnetic plates each of which is made of a magnetic material. These magnetic plates 50 are arranged on an outer circumference of the coil 40 when the lens driving apparatus is assembled. Further, each of the magnetic plates 50 is opposed to each of the two magnets 20 arranged on an inner circumference of the coil 40 across the coil 40.

Reference numerals 60, 61 indicate shafts. Each of these shafts 60, 61 has a circular cross section. The shaft 60 has a diameter which is slightly smaller than an inner diameter of the circular hole 12 formed on the lens holder 10. The shaft 61 has a diameter which is slightly smaller than an inner diameter of the long hole 13 formed on the lens holder 10. It is to be noted that the shafts 60, 61 may be formed with either of a magnetic material or a non-magnetic material.

A reference numeral 70 indicates a cover. The cover 70 is composed of an upper face plate 70a having a substantially square shape and four side face plates 70b hanging from the periphery of the upper face plate 70a. An opening 71 for capturing light into the lens is formed on the upper face plate 70a. Further, two holes 72 to which the shafts 60, 61 are inserted and four long holes 73 to which the convexes 33a of the guiding members 33 are inserted are formed on the upper face plate 70a.

Cutouts 74 are formed on the four side face plates 70b of the cover 70. The cutouts 74 are formed in order to remove the magnetic plates 50 when the cover 70 is covered on the base 30. It is to be noted that each cutout 74 is formed on each of the four side face plates 70b for the following reason. This makes it possible to handle a case where each magnet 20 is arranged on each of all the four side faces 10a of the lens holder 10 and the four magnetic plates 50 are arranged so as to correspond to these respective four magnets 20, as will be described later.

The magnetic plates 50 are attached to the outer circumferential surface of the coil 40 with adhesive or the like and the coil 40 attached with the magnetic plates 50 is arranged on the base 30 when assembled. Next, two shafts 60, 61 are inserted to the circular hole 12 and the long hole 13 of the lens holder 10 so that the lens holder 10 to which the shafts 60, 61 have inserted is accommodated in an accommodation space S of the base from the upper side. At this time, the lower ends of the shafts 60, 61 penetrating through the lens holder 10 are inserted into the holes of the base 30 so as to be firmly fixed. In this state, each of the two magnets 20 is opposed to the coil 40 with a predetermined space. Further, the four side faces 10b of the lens holder 10 are made to be in close contact with the side faces of the guiding members 33. Although not shown in the drawings, the lens is previously attached to the opening 11 of the lens holder 10.

Finally, the cover 70 is attached to the base 30 from the upper side such that the two holes 72 are inserted to the upper ends of the two shafts 60, 61, and four long holes 73 are inserted to the convexes 33a. Accordingly, the lens holder 10 is attached to the base 30 and the cover 70 in a state where the lens holder 10 can be displaced along the shafts 60, 61. Thus, the assembling is completed in a state shown in FIG. 2A.

N poles of the magnets 20 are opposed to the first coil 41 at the upper side and S poles of the magnets 20 are opposed to the second coil 42 at the lower side in the assembled state. Accordingly, when a current signal is applied to the first coil 41 and the second coil 42, the electromagnetic driving force acts on the magnets 20 so that the lens holder 10 slides along the shafts 60, 61.

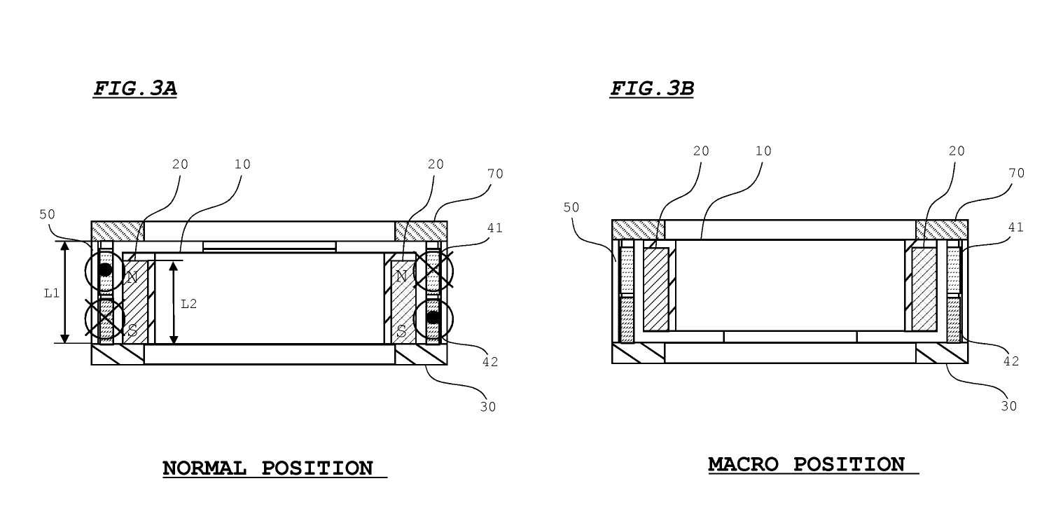

FIGS. 3A and 3B are views for explaining a driving operation of the lens driving apparatus. Note that FIGS. 3A and 3B are cross-sectional views cut along a line A-A′ in FIG. 2A.

FIG. 3A is a view illustrating a state where the lens holder 10 is at the normal position. The normal position is a position of the lens at the time of the normal photographing. When the lens is at the normal position, a lower end of the lens holder 10 abuts against the base 30. As described above, magnetic regions of the N pole and the S pole of magnet 20 are opposed to the first coil 41 and the second coil 42, respectively. Further, current flowing directions in the first coil 41 and the second coil 42 are opposite to each other.

If currents are flown to the first coil 41 and the second coil 42 in the directions as shown in FIG. 3A from a state of the normal position, an upward propulsion force acts on the magnets 20. With this, the lens holder 10 is displaced upward along the shafts 60, 61 from the normal position so as to reach to the macro position as shown in FIG. 3B. The macro position is a position of the lens at the time of the macro photographing. When the lens is at the macro position, an upper end of the lens holder 10 abuts against the cover 70.

If currents are flown to the first coil 41 and the second coil 42 in the directions opposite to the directions as shown in FIG. 3A from a state of the macro position as shown in FIG. 3B, a downward propulsion force acts on the magnets 20. With this, the lens holder 10 is displaced downward along the shafts 60, 61 so as to return to the normal position. Note that in FIG. 3A, black circle marks in circles indicate a direction toward an observer of the drawing and cross marks in circles indicate a direction away from the observer of the drawing.

The lens holder 10 is displaced upward or downward as described above so that the position of the lens is switched between the normal position and the macro position.

As described above, the normal position is set to a position where the lower end (one end) of the lens holder 10 abuts against the base 30. On the other hand, the macro position is set to a position where the upper end (the other end) abuts against the cover 70. With this configuration, the lens can be positioned at the normal position by abutting the lens holder 10 against the base 30. On the other hand, the lens can be positioned at the macro position by abutting the lens holder 10 against the cover 70. Therefore, the lens holder 10 can be easily positioned at an appropriate position if the position of the lens holder 10 is not detected.

Now, at the assembled state, the lens holder 10 receives attractive forces F from two directions perpendicular to each other by magnetic forces generated between the two magnets 20 and two magnetic plates 50 opposed to the magnets 20, as shown in FIG. 4A. Further, the lens holder 10 is attracted in the outer circumferential direction with the attractive forces F so that the shaft 60 is pressed against an inner wall of the hole 12 at the side of the holder center. Therefore, a relatively large frictional force is generated between the shaft 60 and the hole 12. Accordingly, when the lens holder 10 is at the macro position or the normal position, the lens holder 10 is held at the position with the above attractive forces F and frictional force if the current is not supplied to the coil 40.

It is to be noted that as shown in FIG. 4B, a configuration in which the magnets 20 are arranged on the two side faces 10a which are opposed to each other and the magnetic plates 50 are arranged so as to be opposed to the respective magnets 20, in the lens holder 10 can be employed.

With this configuration, the lens holder 10 receives attractive forces F from two directions which are opposite to each other with magnetic forces generated between the magnets 20 and the magnetic plates 50. The lens holder 10 is made to be in a state where the lens holder 10 is hung from the two directions which are opposite to each other with the two attractive forces F. Therefore, even when the lens holder 10 is moved in the vertical direction, the lens holder 10 is hard to be affected with gravity so that driving differences (speed at the time of starting to move, driving response, and the like) between the downward driving time and the upward driving time are hard to be caused. Accordingly, even when the lens driving apparatus is used in a state where the lens holder 10 is moved in the vertical direction, the lens holder 10 can be smoothly driven. Further, when the lens holder 10 is at the macro position or the normal position, the lens holder 10 is held at the position with the above two attractive forces F even when the current is not supplied to the coil 40.

Further, as shown in FIG. 4C, a configuration in which the magnets 20 are arranged on the four side faces 10a and the magnetic plates 50 are arranged so as to be opposed to the respective magnets 20 may be employed. With this configuration, the lens holder 10 is made to be in a state where the lens holder 10 is hung from four directions with the attractive forces F more stably. Therefore, the lens holder 10 is less affected with gravity so that the above driving differences are hard to be caused.

As shown in FIG. 3A, the magnetic plates 50 are configured as follows. That is, a length L1 of the magnetic plates 50 in the optical axis direction of the lens is set to be the same as a distance between the base 30 and the cover 70 such that the length L1 is longer than a length L2 of the magnets 20 in the optical axis direction of the lens. Therefore, the attractive forces F generated between the magnets 20 and the magnetic plates 50 can be stably applied to the lens holder 10 in a range where the lens holder 10 is displaced so that the lens holder 10 can be stably held.

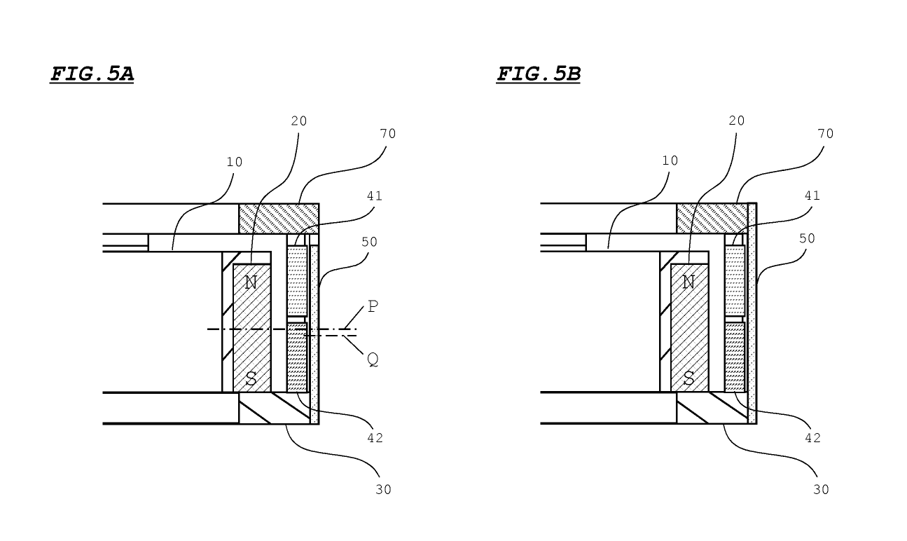

The magnetic plates 50 can be changed to a configuration shown in FIGS. 5A and 5B. In the configuration shown in FIG. 5A, an end of each magnetic plate 50 at the side of the base 30 is extended to an outer bottom surface of the base 30. Therefore, a center Q of each magnetic plate 50 is positioned at the side of the base 30 with respect to a center P of each magnet 20 in a state where the lens holder 10 is at the normal position.

When the length L1 of each magnetic plate 50 is not longer than the length L2 of each magnet 20 very much, the magnet 20 is attracted toward the center of the magnetic plate 50. Therefore, in this case, the magnet 20 is attached to the center Q of the magnetic plate 50 so that the lens holder 10 is attracted to the side of the magnetic plate 50 and to the side of the base 30. The lens holder 10 is usually at the normal position in many cases, and the lens holder 10 can be stably held at the normal position with the above configuration.

In the configuration shown in FIG. 5B, an end of each magnetic plate 50 at the side of the base 30 is extended to the outer bottom surface of the base 30 while an end of each magnetic plate 50 at the side of the cover 70 is extended to an outer top surface of the cover 70. That is to say, the length L1 of each magnetic plate 50 is longer than the length L2 of each magnet 20 as much as possible.

As the difference between the length L1 of each magnetic plate 50 and the length L2 of each magnet 20 is increased in such a manner, a force by which the magnets 20 are attracted toward the centers Q of the magnetic plates 50, that is, an attractive force acting on the optical axis direction (displacement direction) of the lens is decreased. Accordingly, with this configuration, when the lens holder 10 is displaced, the lens holder 10 is hard to be affected by the attractive force in the displacement direction. Therefore, the lens holder 10 can be smoothly driven.

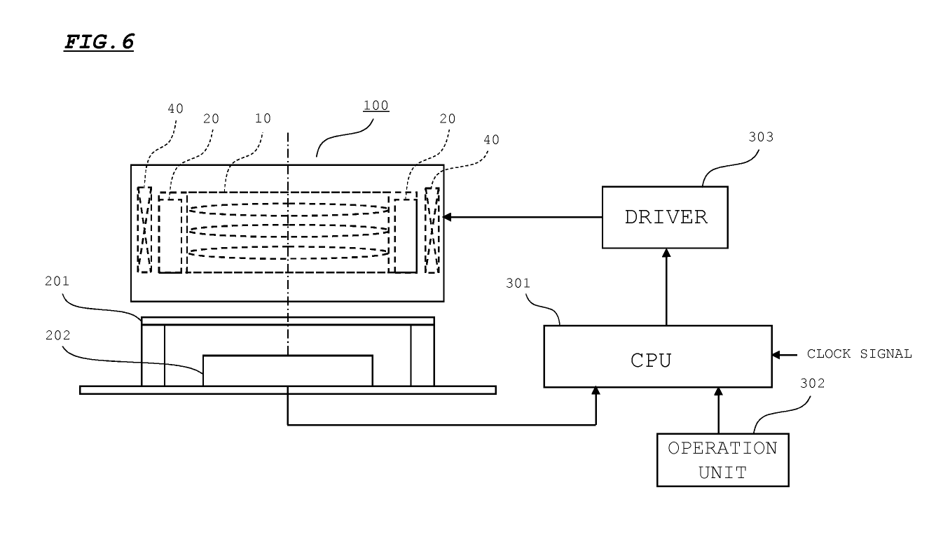

FIG. 6 is a view illustrating a schematic configuration of the imaging apparatus according to the embodiment. The imaging apparatus is mounted on a small-sized camera, or a mobile phone equipped with a camera, for example.

A filter 201 and an image sensor unit 202 are arranged on a lens driving apparatus 100 at the side of the base 30. A contrast signal is output to a CPU 301 from the image sensor unit 202. The contrast signal serves as a barometer for judging whether the lens is focused.

An image signal processor (ISP) is built in the image sensor unit 202. A contrast value of each pixel in an image captured by the image sensor unit 202 is integrated in the ISP. Therefore, an integrated contrast value of the image is calculated so as to be output as a contrast signal. As the lens is focused on a subject more accurately, the image becomes clearer so that the contrast value becomes higher.

A signal for instructing to switch the lens position is output to the CPU 301 from an operation unit 302. The operation unit 302 is composed of an operation button and the like. If a user operates to switch the lens position to the macro position, a signal for instructing to switch the lens position to the macro position is output from the operation unit 302. On the other hand, if the user operates to switch the lens position to the normal position, a signal for instructing to switch the lens position to the normal position is output from the operation unit 302. Note that the operation button for switching the lens position between the macro position and normal position is desired to be arranged at a position where the operation button can be easily operated at the time of photographing by a camera.

When the lens holder 10 is at the normal position, if an instruction to switch the lens position to the macro position is output from the operation unit 302, the CPU 301 outputs a control signal for displacing the lens holder 10 to the macro position to a driver 303. Further, the CPU 301 judges whether the contrast value input from the image sensor unit 202 is lower than a predetermined threshold value. Then, if the contrast value is smaller than the threshold value, the CPU 301 judges that the lens is not focused on the subject since a distance to the subject is too close and outputs a control signal for displacing the lens holder 10 to the macro position to the driver 303.

The driver 303 applies a current signal to the coil 40 of the lens driving apparatus 100 in accordance with the control signal from the CPU 301. With the current signal, the lens holder 10 is displaced to the macro position as shown in FIG. 3B.

On the other hand, when the lens holder 10 is at the macro position, if an instruction to switch the lens position to the normal position is output from the operation unit 302, alternatively, if the CPU 301 judges that the lens is not focused, the CPU 301 outputs a control signal for displacing the lens holder 10 to the normal position to the driver 303. The driver 303 applies a current signal to the coil 40 in accordance with the control signal. With the current signal, the lens holder 10 is displaced to the normal position as shown in FIG. 3A.

In a case where the image captured by the image sensor unit 202 is an image in which color variation is small, the contrast value thereof becomes small as in the case where the lens is not focused. Accordingly, in the case of the image in which color variation is small, there is a risk that it is judged that the lens is not focused and the position of the lens is switched. In the case where the lens is not focused, if the lens is focused by switching the position of the lens, the contrast value is made larger. However, in the case of the image in which color variation is small, even if the position of the lens is switched, the contrast value is kept to be small. Then, the following configuration can be employed. That is, if the contrast value is not made larger than a threshold value even when the position of the lens is switched, a reason that the contrast value is small is not judged to be the focus. Therefore, the lens holder 10 is returned to an original position. With this configuration, even if an error detection is caused, the error detection can be smoothly coped.

As described above, it can be judged whether the position of the lens is appropriate with respect to a distance between the subject and the imaging apparatus (imaging distance) by judging whether the lens is focused. However, it can be judged whether the position of the lens is appropriate by measuring the imaging distance in a practical manner. In this case, a distance sensor by using an infrared laser can be mounted on the imaging apparatus, for example.

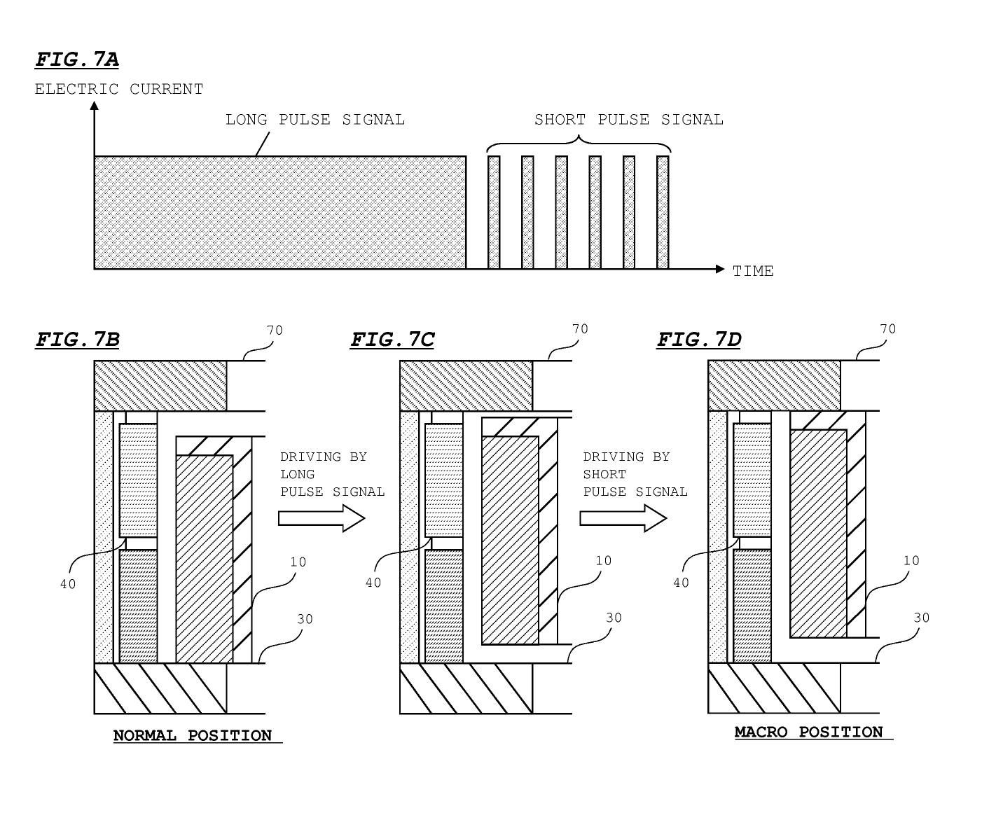

FIGS. 7A, 7B, 7C and 7D are views for explaining a drive control of the lens driving apparatus. FIG. 7A is a waveform chart of a pulse current signal applied to the coil 40 from the driver 303. FIGS. 7B, 7C and 7D are views illustrating motions of the lens holder 10 when the lens holder 10 is driven by the pulse current signals of FIG. 7A. FIGS. 7A, 7B, 7C and 7D are views illustrating an example when the lens holder 10 is displaced from the normal position to the macro position. The same drive control is performed in a case where the lens holder 10 is displaced from the macro position to the normal position.

The pulse current signal as shown in FIG. 7A is applied to the coil 40 from the driver 303 in order to drive the lens holder 10. That is to say, a pulse current signal of which application time is long (hereinafter, referred to “long pulse signal”) is applied to the coil one time, at first. Subsequently, pulse current signals of which application time is short (hereinafter, referred to as “short pulse signal”) is applied to the coil a plurality of times. It is to be noted that all the lengths (application times) of the short pulse signals are set to be the same.

A clock signal for generating a pulse current signal is input to the CPU 301, as shown in FIG. 6. The CPU 301 counts the clock signal with a counter in the CPU 301. Then, the long pulse signal and the short pulse signal are ON/OFF controlled in accordance with the counted result.

That is to say, the CPU 301 firstly outputs an ON signal to the driver 203 so as to make the driver 203 output the long pulse signal. At the same time, the CPU 301 starts to count the clock signal. The CPU 301 continuously outputs the ON signal to the driver 303 until the count value reaches to a clock number corresponding to the application time of the long pulse single. Then, if the count value reaches to the clock number corresponding to the application time of the long pulse signal, the CPU 301 outputs an OFF signal to the driver 203 so as to stop the output of the long pulse signal. Thereafter, if the CPU 301 counts the number of clock signals corresponding to stopping time, the CPU 301 outputs the ON signal to the driver 203 again so as to make the driver 203 output the short pulse signal. Then, if the count value of the clock signal reaches to a clock number corresponding to the application time of the short pulse signal, the CPU 301 outputs the OFF signal to the driver 203 so as to stop the output of the short pulse signal. Then, if the CPU 301 further counts the clock number corresponding to the stopping time, the CPU 301 outputs the ON signal to the driver 303 again until the clock number corresponding to the application time of the short pulse signal is counted. Thereafter, the CPU 301 repeatedly outputs the ON/OFF signal for outputting the short pulse single to the driver 303 by the number of times that the short pulse signals are output.

If the ON signal is input from the CPU 301, the driver 303 outputs a current signal. If the OFF signal is input from the CPU 301, the driver 303 stops the output of the current signal. Thus, the above-described waveform of the pulse current signals is output from the driver 303.

In the embodiment, the displacement amount of the lens holder 10 from the normal position to the macro position is set to be about 0.1 to 0.3 mm, for example. Then, with respect to the displacement amount, the application time of the long pulse time is set to be about several tens to several hundreds ms, for example and the application time of the short pulse signal is set to be about several tens to several hundreds μs, for example. Further, the number of times that the short pulse signal is applied is set to be six. However, the application time or the number of times of application is appropriately determined by a test performed in advance in accordance with the displace amount of the lens holder 10 and other conditions.

A propulsion force (electromagnetic driving force by the coil 40 and the magnets 20) in accordance with the application time of the pulse current signal is applied to the lens holder 10. The lens holder 10 displaces by a distance in accordance with the propulsion force. If the long pulse signal is applied to the coil 40, the lens holder 10 displaces from the normal position as shown in FIG. 7B to the macro position side with the propulsion force and stops at a position as shown in FIG. 7C which is slightly before the macro position. Thereafter, if the short pulse signal is applied to the coil 40 a plurality of times, the lens holder 10 gradually moves to the side of the macro position as shown in FIG. 7D from the position as shown in FIG. 7C with the propulsion force. Then, the lens holder 10 abuts against the cover 70 so as to be positioned at the macro position.

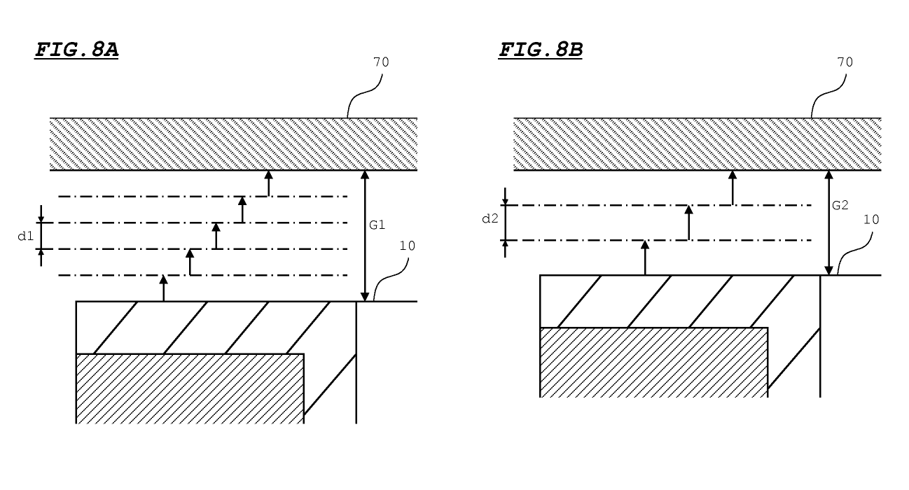

FIGS. 8A and 8B are pattern views illustrating an example of the motion of the lens holder 10 at the time of driving by the short pulse signal. FIG. 8A shows a state where the lens holder 10 is driven against the direction of the gravity. FIG. 8B shows a state where the lens holder 10 is driven along the direction of the gravity. Dashed-dotted lines in FIGS. 8A and 8B indicate stop positions of the lens holder 10 after one short pulse signal is applied.

As shown in FIGS. 8A and 8B, the lens holder 10 gradually moves to the side of the cover 70 each time the short pulse signal is applied. Then, if the lens holder 10 abuts against the cover 70 while the short pulse signal is applied a plurality of times, the lens holder 10 stops at the cover 70.

At this time, the displacement amount of the lens holder 10 is made different depending on the postures of the lens driving apparatus 100 even when the same propulsion force is applied by the short pulse signal. When the lens driving apparatus 100 is at a posture where the lens faces to the upward direction with respect to the horizontal direction, that is, when the macro position is positioned at the upper side of the normal position in the vertical direction, the lens holder 10 is required to be displaced against the gravity. Therefore, as shown in FIG. 8A, a displacement amount d1 of the lens holder 10 with one application of the short pulse signal is small. Further, when the lens holder 10 is driven against the gravity, the displace amount of the lens holder 10 when the long pulse signal is applied is also small. Therefore, the stop position of the lens holder 10 after the long pulse signal is applied, that is, a position of the lens holder 10 when the short pulse signal is started to be applied is largely backward from the cover 70. Namely, the distance G1 from the lens holder 10 to the cover 70 (macro position) is large. Therefore, when the lens holder 10 is driven against the gravity, the number of times that the short pulse signal is applied until the lens holder 10 reaches to the macro position is made large as shown in FIG. 8A.

On the other hand, when the lens driving apparatus 100 is at a posture where the lens faces to the downward direction with respect to the horizontal direction, that is, when the macro position is positioned at the lower side of the normal position in the vertical direction, the lens holder 10 is displaced along the gravity direction. Therefore, as shown in FIG. 8B, a displacement amount d2 of the lens holder 10 with one application of the short pulse signal is large. Further, a distance G2 from the stop position of lens holder 10 after the long pulse signal is applied to the cover 70 (macro position) is small. Therefore, the number of times that the short pulse signal is applied until the lens holder 10 reaches to the macro position is made small.

The time width of the long pulse signal and the number of times that the short pulse signal is applied have been previously adjusted to the time width and the number of application times with which the lens holder 10 reaches to the macro position even in a situation where the lens holder 10 is hard to displace at the most degree with affect of the gravity, or the like. With such setting, the lens holder 10 usually reaches to the normal position before the number of times that the short pulse signal is applied reaches to the set number of times and thereafter, the short pulse signal is continuously applied remaining number of times. However, even if the short pulse signal is applied remaining number of times in such a manner, the lens holder 10 is only pressed against the cover 70 continuously with the propulsion force by application of the remaining short pulse signal(s). Therefore, when the lens holder 10 is positioned at the macro position, these remaining pulse signals never adversely affect.

The lens holder 10 gradually displaces from the vicinity position of the macro position with the propulsion force by the short pulse signal so as to abut against the cover 70. Therefore, the lens holder 10 does not hit against the cover 70 strongly so that the rasping collision sound is not generated. Further, the lens holder 10 is hard to be separated from the cover 70 on the rebound that the lens holder 10 hits the cover 70. Therefore, the lens is prevented from being deviated from the appropriate position.

Even if the lens holder 10 is separated from the cover 70 on the rebound that the lens holder 10 hits the cover 70, the lens holder 10 is pressed against the cover 70 with application of the remaining short pulse signal(s) after the hitting. Therefore, the lens holder 10 is positioned at a position where the lens holder 10 abuts against the macro position.

In order to make the switching time of the lens to the macro position shorter as much as possible, it is sufficient that the application time of the long pulse signal is made longer and the lens holder 10 is displaced to a position as close to the macro position as possible by the long pulse signal. However, in this case, depending on the postures of the lens driving apparatus 100, for example, when the macro position is positioned at the lower side of the normal position in the vertical direction, the lens holder 10 reaches to the macro position with only the propulsion force by the long pulse signal so as to abut against the cover 70. Then, there is a risk that the lens holder 10 is separated from the cover 70 with its rebound (for example, the same state as the state in FIG. 7C). However, in such a case, since the short pulse signal is applied thereafter, the lens holder 10 reaches to the macro position with the propulsion force. Therefore, the position of the lens is prevented from being deviated from the appropriate position.

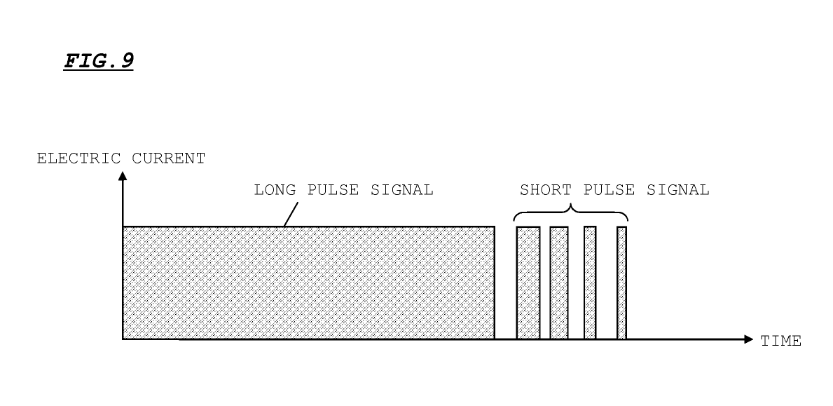

Further, the waveform of the pulse current signal for driving the lens holder 10 can be changed to a waveform as shown in a waveform chart in FIG. 9. In the modification, the width of the short signal (application time) is gradually made shorter in accompanied with the application times. In this case, a period that the short pulse signal is applied is made to be the same, the application time is made longer and the stopping time is made shorter in the earlier application of the short pulse signal.

With this configuration, as the propulsion force by the short pulse signal while the lens holder 10 is separated from the macro position can be made larger. Therefore, the time taken until the lens holder 10 reaches to the macro position from the position where the lens holder 10 stops after the application of the long pulse signal can be made shorter. Further, since the propulsion force after the lens holder 10 is close to the macro position can be made smaller, the lens holder 10 can be softly slided to the macro position.

In an example of FIG. 9, as the number of times of application is increased by one, the width of the short pulse signal is made narrower. However, the width of the short pulse signal may be made smaller every time the short pulse signal is applied n times.

In the above embodiment, a case where the lens holder 10 is displaced from the normal position to the macro position is described as an example. However, also in a case where the lens holder 10 is displaced from the macro position to the normal position, the lens holder 10 can be positioned to the normal position smoothly and appropriately by performing the same control as described above. However, when the lens holder 10 is displaced from the macro position to the normal position, the displacement direction of the lens holder 10 is made to be opposite to that when the lens holder 10 is displaced from the normal position to the macro position. Therefore, the long pulse signal and the short pulse signals as shown in FIGS. 7A and 9 are required to be applied to the coil 40 with the polarity thereof inverted.

According to the embodiment, the position of the lens between the normal position and the macro position can be electrically switched. Therefore, in addition to the switching operation by a user, the position of the lens can be automatically switched by detecting whether the position of the lens is appropriate with respect to the photographing distance.

Further, according to the embodiment, the lens holder 10 is only abutted against the base 30 so as to be positioned at the normal position. On the other hand, the lens holder is only abutted against the cover 70 so as to be positioned at the macro position. Therefore, the lens holder 10 can be easily positioned at the appropriate positions.

According to the embodiment, the lens holder 10 is gradually placed with the short pulse signal from a position before the macro position or the normal position so as to reach to these positions. Therefore, the lens holder 10 never hits the cover 70 or the base 30 strongly. Therefore, the lens holder 10 is hard to be separated from the cover 70 or the base 30 on the rebound that the lens holder 10 hits the cover 70 or the base 30. Further, the rasping collision sound is not generated.

Further, according to the embodiment, the lens holder 10 is held at the macro position or the normal position by using the attractive forces F acted between the magnets 20 and the magnetic plates 50. Therefore, even when the current is not supplied to the coil 40, the lens holder 10 can be positioned at these positions so as to reduce the power consumption.

As described above, the embodiment of the invention has been described. However, the invention is not limited to the embodiment and the embodiment of the invention can be variously modified.

For instance, in the embodiment, the magnet 20 is arranged on the lens holder 10 and the coil 40 is arranged on the base 30. Alternatively, the magnet 20 may be arranged on the lens holder 10 and the coil 40 may be arranged on the base 30.

### Modification of Lens Driving Apparatus

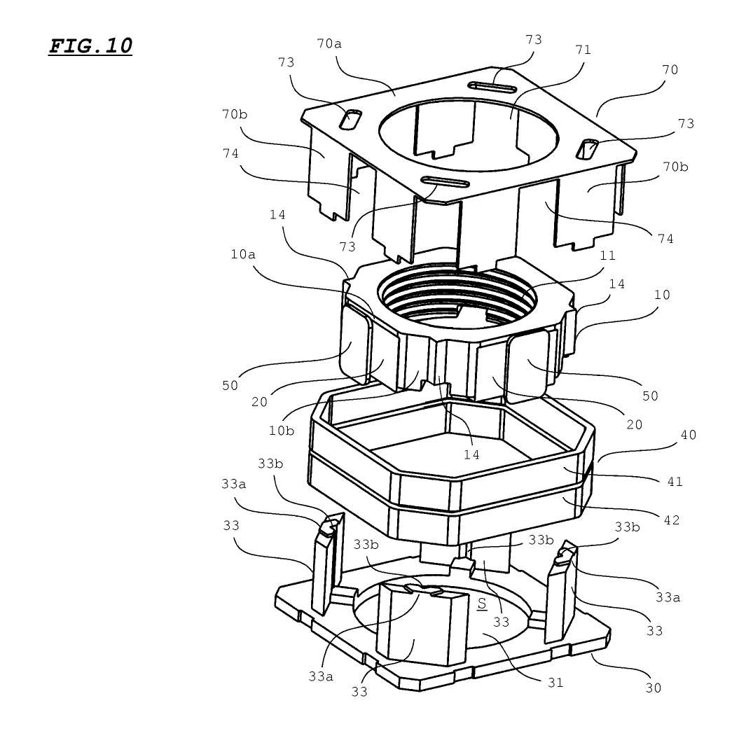

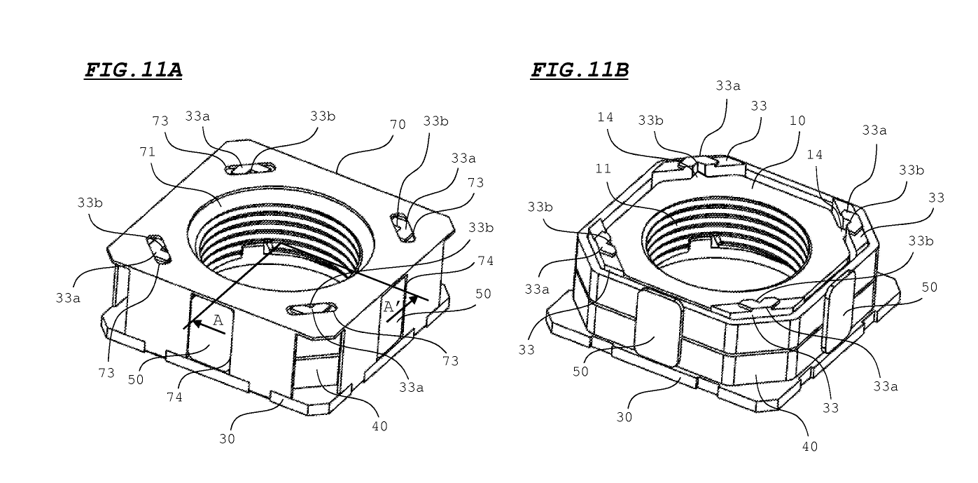

FIG. 10 is an exploded perspective view illustrating a lens driving apparatus according to another embodiment. FIGS. 11A and 11B are views illustrating a configuration of the lens driving apparatus after assembled. FIG. 11A is a view illustrating the lens driving apparatus after completely assembled. FIG. 11B is a view illustrating a state where the cover 70 is removed from the lens driving apparatus so as to see an internal state of the lens driving apparatus shown in FIG. 11A.

In the embodiment, a guiding configuration when the lens holder 10 is moved is not composed of the shafts 60, 61, the circular hole 12 and the long hole 13. As will be described below, the guiding configuration is composed of protrusions 14 and grooves 33b. Other components shown in FIG. 10, FIGS. 11A and 11B are the same as those in the above embodiment.

That is, each protrusion 14 having a triangular cross-sectional shape extending in the vertical direction is formed on each four side face 10b having small width, on the lens holder 10. On the other hand, V-shaped grooves 33b which engage with the respective protrusions 14 are formed on the side faces of guiding members 33 opposed to these side faces 10b.

As shown in FIG. 11B, if the lens holder 10 is attached to the base 30, the protrusions 14 are fitted into the grooves 33b. If the lens holder 10 is moved in the vertical direction in this state, the protrusions 14 are slided in the grooves 33b in accompanied with the movement. With this configuration, the guiding configuration can be easily provided.

### Modification of Imaging Apparatus

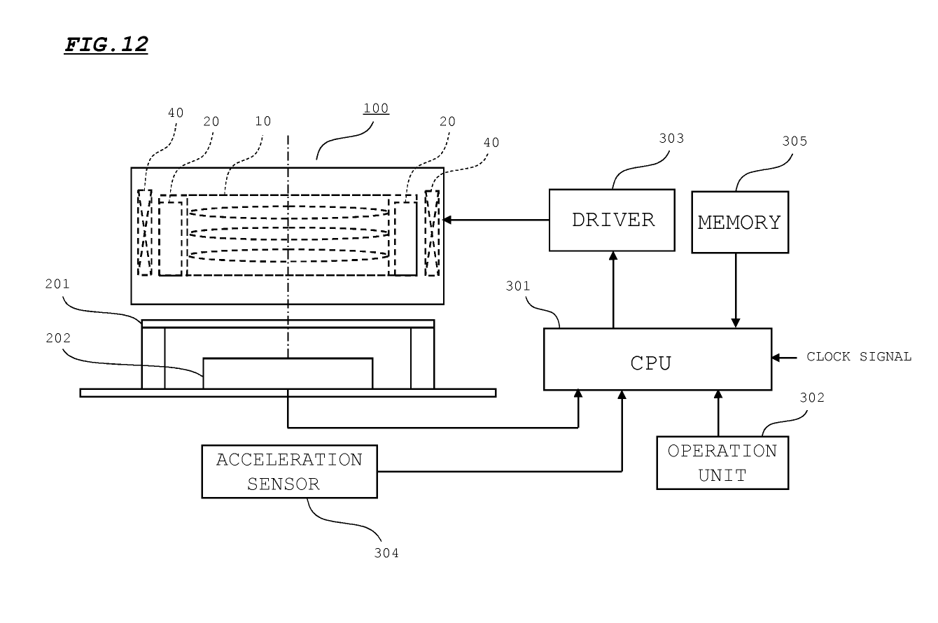

FIG. 12 is a view illustrating a schematic configuration of the imaging apparatus according to another embodiment. In this embodiment, an acceleration sensor 304 for detecting a posture of the lens driving apparatus is arranged. The acceleration sensor 304 has a function of detecting the gravity acceleration in at least one axis direction. The acceleration sensor 304 is arranged such that the one axis direction is the optical axis direction of the lens. A positive acceleration signal is output from the acceleration sensor 304 if the gravity acceleration speed is caused at the side of the base 30. On the other hand, a negative acceleration signal is output from the acceleration sensor 304 if the gravity acceleration speed is caused at the side of the cover 70.

The acceleration signal from the acceleration sensor 304 is input to the CPU 301. The CPU 301 judges that the lens driving apparatus 100 faces to the upward direction with respect to the horizontal direction when the positive acceleration signal is larger. On the other hand, the CPU 301 judges that the lens driving apparatus 100 faces to the downward direction with respect to the horizontal direction when the negative acceleration signal is large. The CPU 301 judges that the lens driving apparatus 100 faces to the horizontal direction when the acceleration signal is zero, or near to zero.

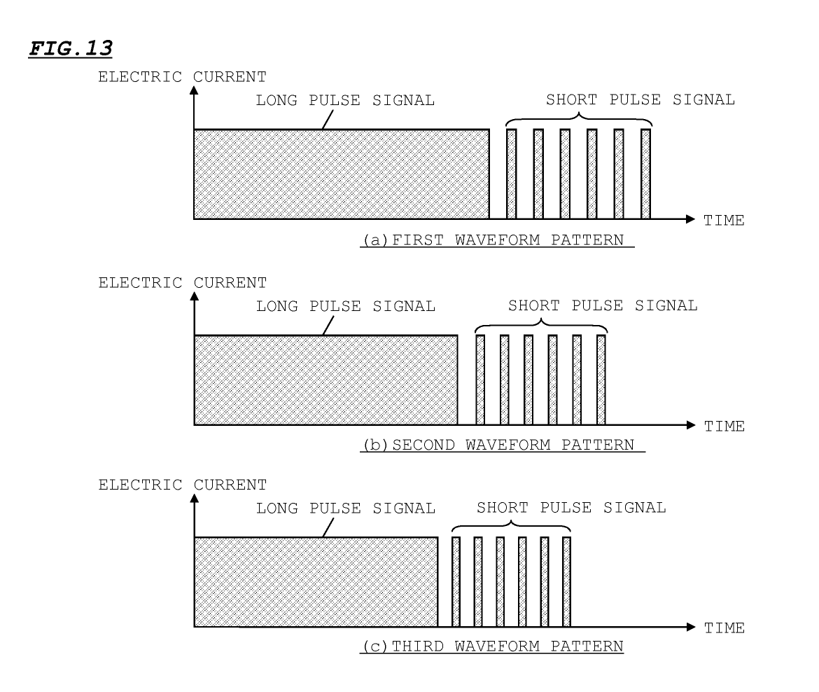

As shown in FIG. 13, waveform patterns of three pulse current signals (first waveform pattern, second waveform pattern and third waveform pattern) for displacing the lens holder 10 from the normal position to the macro position are stored in the memory 305. Each of the first waveform pattern, the second waveform pattern and the third waveform pattern corresponds to each of the cases where the lens driving apparatus 100 faces to the upward direction, the transverse direction and the downward direction respectively. Application times of the long pulse signal and the short pulse signals in the first waveform pattern, the second waveform pattern and the third waveform pattern become shorter in this order. That is to say, application times of the long pulse signal and the short pulse signals become longer as a larger propulsion force is required for displacing the lens holder 10.

When the lens holder 10 is displaced from the normal position to the macro position, the CPU 301 judges the posture of the lens driving apparatus 100. If the posture of the lens driving apparatus 100 is judged to face to the upward direction with respect to the horizontal direction, the CPU 301 judges that a large propulsion force is required. At this time, the CPU 301 outputs a control signal to the driver 303 such that the pulse current signal having the first waveform pattern is applied to the coil 40. Further, if the posture of the lens driving apparatus 100 is judged to face to the substantially horizontal direction, the CPU 301 judges that a normal propulsion force is required. At this time, the CPU 301 outputs a control signal to the driver 303 such that a pulse current signal having the second waveform pattern is applied to the coil 40. In addition, if the posture of the lens driving apparatus 100 is judged to face to the downward direction with respect to the horizontal direction, the CPU 301 judges that a small propulsion force is required. At this time, the CPU 301 outputs a control signal to the driver 303 such that a pulse current signal having the third waveform pattern is applied to the coil 40.

When the lens holder 10 is displaced from the macro position to the normal position, if the posture of the lens driving apparatus 100 faces to the upward direction with respect to the horizontal direction, the CPU 301 outputs a control signal to the driver 303 such that a pulse current signal having the third waveform pattern is applied to the coil 40. If the posture of the lens driving apparatus 100 faces to the downward direction with respect to the horizontal direction, the CPU 301 outputs a control signal to the driver 303 such that a pulse current signal having the first waveform pattern is applied to the coil 40. If the posture of the lens driving apparatus 100 is judged to face to the substantially horizontal direction, a pulse current signal having the second waveform pattern is applied to the coil 40 as in the above case. It is to be noted that in this case, the displacement direction when the lens holder 10 is displaced from the macro position to the normal position is opposite to that when the lens holder 10 is displaced from the normal position to the macro position. Therefore, the pulse current signals having the first, second and third waveform patterns are required to be applied to the coil 40 with the polarities thereof inverted.

Thus, according to the embodiment, the application time of the pulse current signals (long pulse signal, short pulse signals) is adjusted depending on the postures of the lens driving apparatus 100. That is, in a state where the lens holder 10 is not easily moved, the application time of the pulse current signal is made longer. In contrast, in a state where the lens holder 10 is easily moved, the application time of the pulse current signal is made shorter. Therefore, the pulse signals can be suppressed from being applied more than necessary. As a result, the power consumption required for the driving can be reduced.

The following configuration may be employed. That is, the above waveform patterns are not stored in the memory 305, and an operation expression for calculating the application time of the long pulse signal and the short pulse signals in accordance with the acceleration signal is stored. Then, the application time is calculated from the acceleration signal detected in the imaging situation based on the operation expression. With such a configuration, the pulse current signal in accordance with the postures of the lens driving apparatus 100 can be applied to the coil 40 as in the case where the waveform patterns are stored.

A current amount by the application of the short pulse signal by a plurality of times is significantly smaller than that by the application of the long pulse signal. Therefore, when the waveform pattern is changed depending on the postures of the lens driving apparatus as described above, a large effect of the reduction in the power consumption can be obtained by changing the application time of the long pulse signal rather than the short pulse signal. Accordingly, when the waveform pattern is adjusted in such a manner, only the application time of the long pulse signal may be changed while the application time of the short pulse signal is kept to be constant.

Further, other known sensors for inclination detection can be used instead of the acceleration sensor 304 in order to detect the posture of the lens driving apparatus 100. Further, the acceleration sensor may be arranged at the side of the small-sized camera main body or the mobile phone equipped with a camera not at the side of the imaging apparatus.

### Application Example to Auto-Focus Function

The imaging apparatus according to the invention can be applied to an imaging apparatus on which a lens driving apparatus for auto-focus is mounted. In this case, the lens driving apparatus for auto-focus may have a configuration as that of the lens driving apparatus 100 according to the above embodiment. In the case of the lens driving apparatus for auto-focus, the normal position as shown in FIG. 3A corresponds to a home position of the lens when the focus is adjusted. Then, the lens holder 10 is driven from the home position to the on-focus position.

That is to say, when the auto-focus operation is started, the pulse current signal is applied to the coil 40 a predetermined number of times and the lens holder 10 which holds the lens is gradually displaced in the optical axis direction of the lens from the home position. Every time the lens and the lens holder 10 are displaced by one pulse current signal, the contrast value of the image captured by the lens can be detected based on the signal from the image sensor unit 202. The detection of the contrast value is repeated until the lens and the lens holder 10 reach to a terminal position of the focus adjustment region from the home position by application of the pulse current signal by all of the plurality of number of times. At this time, the contrast value becomes maximum when the lens and the lens holder 10 are at the on-focus position.

Thereafter, the contrast values of each of the applications are compared to each other so that what number of application of the pulse current signal makes the contrast value maximum is extracted. Then, after the lens is returned to the home position once, the lens and the lens holder 10 are placed from the home position again by application of the pulse current signals by the extracted number of times. Therefore, the lens is positioned at a position where the contrast value is maximum, that is, at the on-focus position.

In such focusing operation, when the lens holder 10 is returned from the terminal position of the focus adjustment region to the home position, the pulse current signal including the long pulse signal and a plurality of short pulse signals is used as shown in FIGS. 7A, 9, and 13. In this case, the displacement direction of the lens holder 10 when the lens holder 10 is returned from the terminal position of the focus adjustment region to the home position is opposite to that of the lens holder 10 when the lens holder 10 is displaced from the normal position to the macro position as described above. Therefore, the pulse current signal as shown in FIGS. 7A, 9, and 13 is applied to the coil 40 in the state where the polarity thereof is inverted. Therefore, the lens holder 10 is positioned at the home position appropriately. Accordingly, focusing operation to the on-focus position can be prevented from getting out of order. As a result, the focus adjustment accuracy can be improved.

In addition, the embodiment of the invention can be variously modified as appropriate in a range of a technical scope as described in the Claims.

What is claimed is:

1. An imaging apparatus comprising:
a holder which holds a lens;
a supporting unit which supports the holder so as to be displaced in the optical axis direction of the lens;
an abutment unit which is provided on the supporting unit and abuts against the holder when the holder is positioned at a predetermined reference position;
a magnet which is arranged on any one of the holder and the supporting member;
a coil which is arranged so as to be opposed to the magnet and generates an electromagnetic driving force on the holder with the magnet when an electric current is applied;
a magnetic member which holds the holder at a position after the current supply is stopped with a magnetic force generated between the magnet and the magnetic member, when the current supply to the coil is stopped; and
a control unit which driving-controls the holder by applying a current signal to the coil,
wherein when the holder is displaced to the reference position, the control unit applies a first pulse current signal to the coil, then applies a second pulse current signal of which application time is shorter than that of the first pulse current signal to the coil a plurality of times.

2. The imaging apparatus according to claim 1, further comprising a posture detection unit which outputs a detection signal in accordance with a posture of the imaging apparatus,
wherein the control unit adjusts an application time of at least the first pulse current signal in accordance with the detection signal from the posture detection unit.

3. The imaging apparatus according to claim 2,
wherein the application time of the first pulse current signal is set based on the degree that gravity is applied to the imaging apparatus.

4. The imaging apparatus according to claim 3,
wherein the control unit sets the application time of the first pulse current signal such that the application time of the first pulse current signal is longer when the posture of the imaging apparatus faces to an upward direction with respect to the horizontal direction, and the application time of the first pulse current signal is shorter when the posture of the imaging apparatus faces to a downward direction with respect to the horizontal direction.

5. The imaging apparatus according to claim 1,
wherein the second pulse current signal applied a plurality of times is configured such that the application time is gradually shorter as the later application of the second pulse signal.

6. The imaging apparatus according to claim 1,
wherein the magnet and the magnetic member are arranged on the holder and the supporting member, respectively, so as to be opposed to each other, and
the length of the magnetic member in the optical axis direction is set to be longer than that of the magnet in the optical axis direction.
